(19) United States
(12) Patent Application Publication
(10) Pub. No.: US 2026/0336939 A1
(43) Pub. Date: Oct. 29, 2026

(54) CABLE-SUSPENDED OVERLAND CONVEYOR SYSTEMS

(71) Applicant: VIRTA, INC., Carlsbad, CA (US)

(72) Inventor: Ruben Elias LEZIUS, Carlsbad, CA (US)

(21) Appl. No.: 19/120,569

(22) PCT Filed: Oct. 13, 2022
(86) PCT No.: PCT/US2022/046581

§ 371 Date: Apr. 11, 2025

(51) Int. Cl. B65G 21/04; B65G 39/12

(52) U.S. Cl. CPC B65G 21/04; B65G 39/12

(57) ABSTRACT

A conveyor system extending between an infeed end and an outfeed end and including a foundation positioned on a terrain, the foundation including a plurality of idler sheaves, a cable assembly extending from the infeed end to the outfeed end and supported on the foundation, the cable assembly including an elongate support cable rollably supported by the plurality of idler sheaves, and a conveyor belt extending from the infeed end to the outfeed end and freely supported on the cable assembly whereby a load path is defined that extends from the conveyor belt, through the cable assembly, and to the foundation.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Conveyor systems are utilized in a variety of diverse applications for transporting equipment and materials (e.g., bulk materials) from one location to another. As an example, overland conveyors comprise a type of conveyor system which may be used to convey equipment and/or materials overland including across both relatively flat and uneven terrain. Conveyor systems may generally be divided into three sections: an infeed end which includes one of a pair of end or deflection pulleys forming the looped belt, an outfeed end including the other end pulley of the looped belt, and a mid-section extending between the infeed and outfeed ends. An endless or continuous conveyor belt travels between the infeed end and the outfeed end where the conveyor belt is looped around the pair of end pulleys of the infeed and outfeed ends. Additionally, the mid-section of conveyor systems typically includes a support structure located between the infeed and outfeed ends and which include a plurality of support or idler rollers which physically support the weight of the conveyor belt as the conveyor belt is driven continuously between the infeed and outfeed ends. Additionally, conveyor systems include drive stations at one of or both of the infeed and outfeed ends thereof for powering the travel of the conveyor belt therebetween.

### BRIEF SUMMARY

An embodiment of a conveyor system extending between an infeed end and an outfeed end comprises a foundation positioned on a terrain, the foundation comprising a plurality of idler sheaves, a cable assembly extending from the infeed end to the outfeed end and supported on the foundation, the cable assembly comprising an elongate support cable rollably supported by the plurality of idler sheaves, and a conveyor belt extending from the infeed end to the outfeed end and freely supported on the cable assembly whereby a load path is defined that extends from the conveyor belt, through the cable assembly, and to the foundation. In some embodiments, the support cable is rollably supported by the plurality of idler sheaves through metal-to-metal contact between the support cable and the plurality of idler sheaves. In some embodiments, the plurality of idler sheaves each comprise a radially outer concave contact surface in contact with the support cable of the cable assembly. In certain embodiments, the cable assembly comprises a plurality of carry frames coupled along the support cable, and wherein the conveyor belt is held in position on the plurality of carry frames through static friction between the conveyor belt and the plurality of carry frames. In certain embodiments, each of the plurality of carry frames comprises a connector that couples the carry frame to the support cable. In some embodiments, the foundation comprises a plurality of spaced support towers, each support tower comprising a vertically extending tower column and an idler support frame positioned atop the tower column, wherein at least one of the plurality of idler sheaves is coupled to the idler support frame. In certain embodiments, the foundation comprises a stringer that comprises an idler support frame positioned along the surface of the terrain and on which the plurality of idler sheaves are positioned. In certain embodiments, the conveyor system comprises an end section corresponding to one of the infeed end and the outfeed end of the conveyor system, wherein the end section comprises one or more driven sheaves configured to apply a tension to the cable assembly, and a driven pulley configured to separately apply a tension to the conveyor belt. In some embodiments, the conveyor system comprises an end section corresponding to one of the infeed end and the outfeed end of the conveyor system, wherein the end section comprises one or more deflection sheaves configured to separate the cable assembly from the conveyor belt whereby the cable assembly is directed in a first direction while the conveyor belt is directed in a second direction disposed at a non-zero angle from the first direction.

An embodiment of a conveyor system extending between an infeed end and an outfeed end comprises a foundation positioned on a terrain, a cable assembly extending from the infeed end to the outfeed end and supported on the foundation, a conveyor belt extending from the infeed end to the outfeed end and freely supported on the cable assembly whereby a load path is defined that extends from the conveyor belt, through the cable assembly, and to the foundation, and an end section corresponding to one of the infeed end and the outfeed end of the conveyor system, wherein the end section comprises one or more driven sheaves configured to apply a tension to the cable assembly, and a driven pulley configured to separately apply a tension to the conveyor belt. In some embodiments, the end section comprises a first powertrain configured to apply a rotational torque to the one or more driven sheaves, and a second powertrain configured to separately apply a rotational torque to the driven pulley. In some embodiments, the foundation comprises a plurality of idler sheaves, and the cable assembly comprises an elongate support cable extending from the infeed end to the outfeed end of the conveyor system and rollably supported by the plurality of idler sheaves. In certain embodiments, the cable assembly comprises a plurality of carry frames, and wherein the conveyor belt is held in position on the plurality of carry frames through static friction between the conveyor belt and the plurality of carry frames. In certain embodiments, the cable assembly comprises an elongate support cable extending from the infeed end to the outfeed end of the conveyor system, and wherein each of the plurality of carry frames comprises a connector that couples the carry frame to the support cable. In some embodiments, the end section comprises one or more deflection sheaves configured to separate the cable assembly from the conveyor belt whereby the cable assembly is directed in a first direction while the conveyor belt is directed in a second direction disposed at a non-zero angle from the first direction.

An embodiment of a conveyor system extending between an infeed end and an outfeed end comprises a foundation positioned on a terrain, a cable assembly extending from the infeed end to the outfeed end and supported on the foundation, a conveyor belt extending from the infeed end to the outfeed end and freely supported on the cable assembly whereby a load path is defined that extends from the conveyor belt, through the cable assembly, and to the foundation, and an end section corresponding to one of the infeed end and the outfeed end of the conveyor system, wherein the end section comprises one or more deflection sheaves configured to separate the cable assembly from the conveyor belt whereby the cable assembly is directed in a first direction while the conveyor belt is directed in a second direction disposed at a non-zero angle from the first direction. In some embodiments, the foundation comprises a plurality of idler sheaves, and the cable assembly comprises an elongate support cable extending from the infeed end to the outfeed end of the conveyor system and rollably supported by the plurality of idler sheaves. In some embodiments, the cable assembly comprises a plurality of carry frames, and wherein the conveyor belt is held in position on the plurality of carry frames through static friction between the conveyor belt and the plurality of carry frames. In certain embodiments, the cable assembly comprises an elongate support cable extending from the infeed end to the outfeed end of the conveyor system, and wherein each of the plurality of carry frames comprises a connector that couples the carry frame to the support cable. In certain embodiments, the foundation comprises a plurality of spaced support towers, each support tower comprising a vertically extending tower column and an idler support frame positioned atop the tower column, wherein a plurality of idler sheaves are coupled to the idler support frame and which rollably support the cable assembly.

### BRIEF DESCRIPTION OF THE DRAWINGS

For a detailed description of various exemplary embodiments, reference will now be made to the accompanying drawings in which:

FIG. 1 is a plan view of a mid-section of an embodiment of a conveyor system in accordance with principles described herein;

FIG. 2 is an end view of the mid-section of the conveyor system of FIG. 1;

FIG. 3 is a side view of an embodiment of a foundation of a conveyor system in accordance with principles described herein;

FIG. 4 is a side view of another embodiment of a foundation of a conveyor system in accordance with principles described herein;

FIG. 5 is a plan view of an embodiment of an end section of the conveyor system of FIG. 1 in accordance with principles described herein;

FIG. 6 is a side view of a carry side of the end section of FIG. 5; and FIG. 7 is a side view of a return side of the end section of FIG. 5.

### DETAILED DESCRIPTION OF EXEMPLARY DISCLOSED EMBODIMENTS

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a part), while the terms “radial” and “radially” generally mean perpendicular to the given axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

As previously described above, conventional conveyor systems are generally composed of an endless conveyor belt supported by a support structure and driven continuously between an infeed and an outfeed end thereof, the infeed and outfeed ends defining the terminal ends of the conveyor system. Particularly, the conveyor belt is typically in the form of a continuous loop that is looped around the end pulleys of the infeed and outfeed ends. Generally, the looped portions of the conveyor belt are arranged vertically where a vertical top (carry) belt or strand of the conveyor belt is positioned vertically above a lower return belt of the conveyor belt. Idler rollers supported on the support structure of the mid-section of the conveyor system are used along top and bottom belts to guide the belt direction and to provide vertical support between the pair of end pulleys. Such configurations allow bulk material to be transported on the top belt from the infeed end of the conveyor system towards the outfeed end of the conveyor system while the looped transition between the top belt and lower belt allows the bulk material carried thereon to be unloaded or “tipped off the belt” at the outfeed end.

The overall length of a given conveyor system extending between the infeed and outfeed ends thereof is generally contingent on the amount of power that may be delivered from the drive stations of the conveyor system to the conveyor belt thereof, and the tensile strength of the conveyor belt where it may be understood that an increase in the amount of power transferred to the conveyor belt from the drive stations results in a concomitant increase in the amount of tensile loads applied to the conveyor belt. In some applications, the distance separating the initial or pickup location from which the materials transported by the conveyor system are picked up by the conveyor system and a delivery location at which it is desired to transport the materials by the conveyor system may exceed the maximum length of the conveyor system. In other words, the distance separating the pickup and delivery locations may require an amount of power delivered from the drive stations and an amount of tensile strength of the conveyor belt that is impractical for many applications. In other words, the amount of power required to transfer materials continuously between the pickup and delivery locations along a single continuous conveyor belt may exceed that which may be practically delivered to the conveyor belt, or may result in tensile loads which exceed the tensile strength of the conveyor belt.

In applications where it is impractical to transport materials continuously between pickup and delivery locations along a single conveyor system, multiple conveyor systems may be arranged end-to-end with transfer stations arranged between the outfeed end of a first conveyor system and an infeed end of an adjacently positioned second conveyor system. In this manner, the transfer station may transfer the materials conveyed along the first conveyor system from the outfeed end of the first conveyor system to the infeed end of the second conveyor system. For example, materials may be vertically dropped from the outfeed end of the first conveyor system onto the infeed end of the second conveyor system. However, transfer stations may reduce the speed, efficiency, and reliability in transporting the materials from the pickup location to the delivery location. For example, at least some of the materials may be lost due to the formation of dust and/or spillage in the process of transferring them from a first conveyor system to a second conveyor system. Additionally, the transfer station may impart additional loads onto the infeed end of the second or receiving conveyor system which may reduce the reliability and increase the rate of wear of components of the second conveyor system. Thus, for these and other reasons, it is generally preferred to minimize the number of transfer stations located between the pickup location to the delivery location. Conventional conveyor systems may include so called “booster sections” located between the infeed and outfeed ends thereof for providing additional or supplemental power to the conveyor belt with the intent of maximizing the overall length of the conveyor system. However, the inclusion of booster sections may undesirably add to the overall cost and complexity of the resulting conveyor system. For example, typically each booster section defines an inline transfer point of the conveyor system, and thus the inclusion of booster sections undesirably increases the number of transfer points along the conveyor system.

Accordingly, embodiments of conveyor systems are described herein which include a cable assembly for frictionally supporting a conveyor belt of the conveyor system. In this configuration, the cable assembly may physically support the conveyor belt while being powered or driven separately from the conveyor belt. In other words, embodiments of conveyor systems described herein include end sections in which the cable assembly is separated from the conveyor belt by one or more deflection sheaves. The separated portion of the cable assembly may be driven by one or more driven sheaves of the end section while the conveyor belt may be separately driven by a driven pulley of the end section, whereby the amount of tension applied to the cable assembly and conveyor belt may be maximized, in-turn maximizing the carrying capacity, carrying speed, and/or longitudinal length of the conveyor belt. Additionally, by supporting the conveyor belt on the cable assembly, frictional drag between the conveyor belt/cable assembly and a foundation of the conveyor system may be limited to rolling contact between a pair of support cables of the cable assembly and idler sheaves of the foundation, where it may be understood that the surface area of frictional contact between the support cables and the idler sheaves is substantially less than the surface area of frictional contact between conventional idler rollers and conveyor belts of conventional conveyor systems. This reduction in frictional drag between the conveyor belt/cable assembly and the foundation of the embodiments of conveyor systems described herein may allow for the additional maximization of the carrying capacity, carrying speed, and/or longitudinal length of the conveyor belt. Further, embodiments of conveyor systems described herein may utilize relatively low cost and commonly available equipment to in-turn minimize the overall costs associated with assembling the conveyor system.

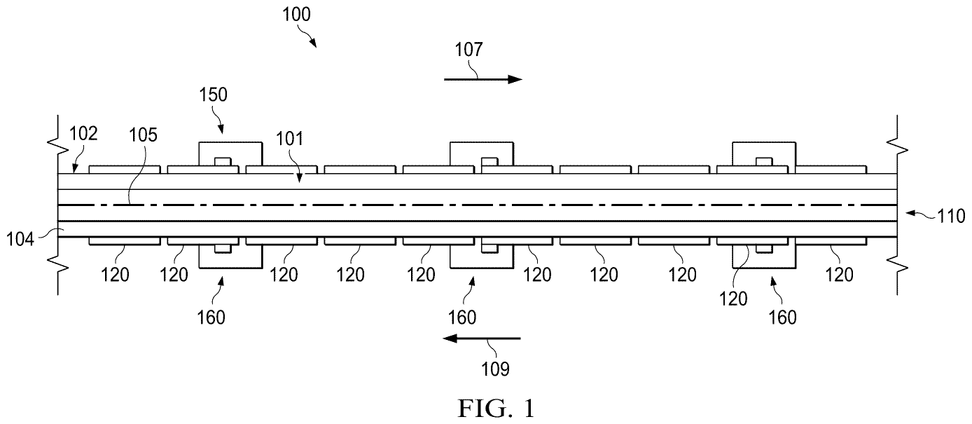

Referring to FIG. 1, an embodiment of a conveyor system 100 is shown. Particularly, FIG. 1 illustrates an end view of a mid-section 150 of the conveyor system 100. In this exemplary embodiment, conveyor system 100 comprises an overland conveyor and may also be referred to herein as overland conveyor system 100; however, it may be understood that in other embodiments conveyor system 100 may comprise conveyor systems other than overland conveyors to maximize the energy efficiency of the conveyor system while permitting the conveyor system to extend across a variety of different terrains.

As shown in FIG. 1, conveyor system 100 extends along a longitudinal axis 105 and includes a continuous or endless conveyor belt 102 that is formed into a continuous loop having a top or carry side 101 and a bottom or return side 103 where the carry side 101 of conveyor belt 102 is located vertically above the return side 103. Additionally, conveyor belt 102 defines a pair of opposing surfaces-a first conveyor surface 104 and an opposing second conveyor surface 106 opposite the first conveyor surface 104. During operation of conveyor system 100, the carry side 101 of conveyor belt 102 is conveyed in a first longitudinal direction (indicated by arrow 107 in FIG. 1) while the return side 103 of conveyor belt 102 (hidden from view in FIG. 1) is simultaneously conveyed in an opposing second longitudinal direction (indicated by arrow 109 in FIG. 1).

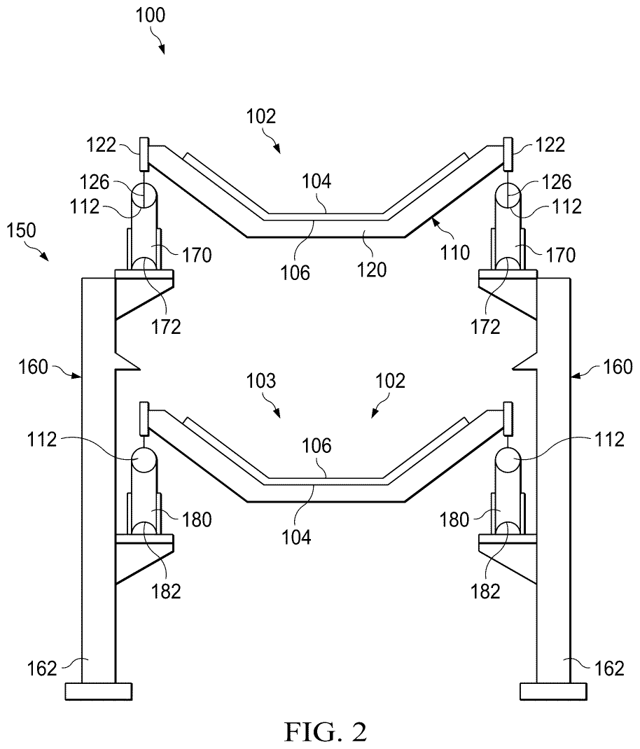

Conveyor system 100 additionally includes a cable assembly 110 which extends along the longitudinal axis 105 thereof and physically supports the conveyor belt 102 along the mid-section 150 of conveyor system 100. In this exemplary embodiment, cable assembly 110 comprises a pair of outer support cables 112 and a plurality of carry frames 120 spaced longitudinally along the longitudinal axis 105 of conveyor system 100. In some embodiments, carry frames 120 may be spaced apart from each other by a given distance which may vary depending on the given application. As shown particularly in FIG. 2, each carry frame 120 extends between a pair of opposing lateral sides 122 defining a concave support surface 124 formed therebetween. The concave support surface 124 defines a concave recess in which the conveyor belt 102 of conveyor system 100 is received. In this exemplary embodiment, each carry frame 120 has a U-or V-shaped profile defining the concave support surface 124; however, it may be understood that in other embodiments the geometry of carry frames 120 may vary. For example, in some embodiments, each carry frame 120 may have a rectangular profile defining a planar support surface 124 on which the conveyor belt 102 is freely supported. As used herein, the term “freely supported” means the conveyor belt 102 is not fastened or otherwise attached to the cable assembly 110 and instead relative movement is restricted between the conveyor belt 102 and the carry frames 120 of cable assembly 110 only through frictional contact (generally static friction) between the conveyor belt 102 and carry frames 120.

The conveyor belt 102 is positioned freely on the concave support surface 124 of each carry frame 120 but is not attached to the concave support surface 124 by fasteners or other attachment mechanisms. In other words, conveyor belt 102 is held in position on the concave support surface 124 of each carry frame 120 through static friction applied between the conveyor belt 102 and the concave support surface 124 of each carry frame 120. The relatively high degree of static friction between conveyor belt 102 and carry frames 120, as well as the minimal contact area between support cables 112 and idler sheaves of the conveyor system 100 as will be discussed further herein, may allow for conveyor system 100 to extend about relatively tighter curves than compared to conventional overland conveyors. The conveyor belt 102 being formed from a flexible material conforms to the profile of the concave support surface 124 of each carry frame 120 as shown in FIG. 2. As will be discussed further herein, the free positioning of conveyor belt 102 on the concave support surface 124 of each carry frame 120 allows for the separation of cable assembly 110 from conveyor belt 102 at the infeed and outfeed ends of conveyor system 100.

In this exemplary embodiment, each carry frame 120 includes a plurality of cable connectors 126 positioned along the lateral sides 122 thereof. Cable connectors 126 extend from the lateral sides 122 of each carry frame 120 and into the pair of support cables 112 thereby coupling or attaching the carry frame 120 to the pair of support cables 112. For example, cable connectors 126 may thread into the support cables 112 to couple the carry frames 120 to the pair of support cables 112. For example, in some embodiments, each of the support cables 112 may comprise a wire rope formed from bundled steel cables or wires, and each cable connector 126 may comprise an elongate member that is stabbed or threaded into a given support cable 112. However, it may be understood that the configuration of cable connectors 126 may vary in other embodiments. For example, in other embodiments, cable connectors 126 may comprise clamps which clamp onto the outer surface of a given support cable 112 to attach the cable connector 126 to the support cable 112. In this exemplary embodiment, relative movement between the carry frames 120 and the pair of support cables 112 along the longitudinal axis 105 of conveyor system 100 is restricted. Additionally, the conveyor belt 102 itself is not attached to the pair of support cables 112 and thus is permitted to separate from the pair of support cables 112 at the infeed and outfeed ends of the conveyor system 100, as will be discussed further herein.

In this exemplary embodiment, the mid-section 150 of conveyor system 100 generally includes a plurality of structural supports or foundations 160 spaced along the longitudinal axis 105 of conveyor system 100. It may be understood that the spacing of foundations 160 along longitudinal axis 105 may vary substantially depending on the given application and, particularly, on the type of terrain over which the conveyor system 100 extends. In this exemplary embodiment, each foundation 160 comprises a support frame 162, a set of carry sheaves 170 rotatably mounted to the support frame 162, and a set of return sheaves 180 also rotatably mounted to the support frame 162. Support frames 162 may extend vertically from the conveyor belt 102 to the terrain over which the conveyor belt 102 extends whereby loads may be transferred from the conveyor belt 102 and cable assembly 110 of conveyor system 100 to the terrain through the support frames 162 of foundations 160. As will be discussed further herein, the configuration of support frames 162 may vary substantially depending on the type of terrain over which the conveyor system 100 extends.

Carry sheaves 170 of each foundation 160 are positioned vertically above the return sheaves 180 and physically support the carry side 101 of the conveyor belt 102 while the return sheaves 180 physically support the return side 103 of conveyor belt 102. Each sheave 170, 180 may couple to a given support frame 162 via a bearing mount whereby the given sheave 170, 180 is permitted to freely rotate relative to the support frame 162 about a rotational axis associated with the sheave 170, 180. Additionally, in this exemplary embodiment, each of the sheaves 170, 180 defines a radially outer concave contact surface 172, 182, respectively, which contacts and physically supports the support cables 112 of cable assembly 110 during the operation of conveyor system 100. In this configuration, the concave contact surfaces 172, 182 of sheaves 170, 180, respectively, define curved recesses in which the support cables 112 may be partially received.

It may be understood that in this exemplary embodiment the foundation 160 does not include any additional conventional rollers for contacting the carry frames 120 of cable assembly 110, and instead loads from the carry frames 120 are transferred to the support frames 162 of foundation 160 entirely through the contact made between support cables 112 and the sheaves 170, 180 of foundation 160. To state in other words, the weight of conveyor belt 102 (including the weight of materials deposited thereon) and of carry frames 120 is born entirely by the pair of support cables 112, which transfer the weight of conveyor belt 102 and carry frames 120 to the foundations 160, and from foundations 160 to the terrain to which the foundations 160 are affixed. In this manner, the contact area between cable assembly 110 and foundation 160 may be minimized to the contact that occurs between support cables 112 and sheaves 170, 180 of foundation 160. The minimization of the contact area between cable assembly 110 and foundation 160 may in-turn desirably minimize the degree of friction between cable assembly 110 and foundation 160. Additionally, it may be understood that while frictional contact occurs between the carry frames 120 of cable assembly 110 and the conveyor belt 102, the frictional contact between carry frames 120 and conveyor belt 102 is generally static, and thus does not produce a frictional drag on the conveyance of the cable assembly 110 and conveyor belt 102 along the longitudinal length of the conveyor system 100. Further, in addition to the reduction in frictional drag, sheaves 170, 180 do not overlap the conveyor belt 102 and instead are located external and flank the lateral sides of conveyor belt 102. In this arrangement, sheaves 170, 180 are relatively easier to access by maintenance personnel than conventional idler rollers which are typically positioned directly beneath the conveyor belt.

Additionally, the degree of friction between support cables 112 and sheaves 170, 180 may be minimized based on the materials comprising cables 112 and sheaves 170, 180. For example, in some embodiments, support cables 112 may comprise steel cables and sheaves 170, 180 may also be formed from steel, resulting in a relatively low friction metal-to-metal contact interface therebetween. It may be understood that minimizing friction between cable assembly 110 and each foundation 160 may minimize the amount of power that must be inputted to conveyor belt 102 and cable assembly 110 to transport the conveyor belt 102 across a given distance.

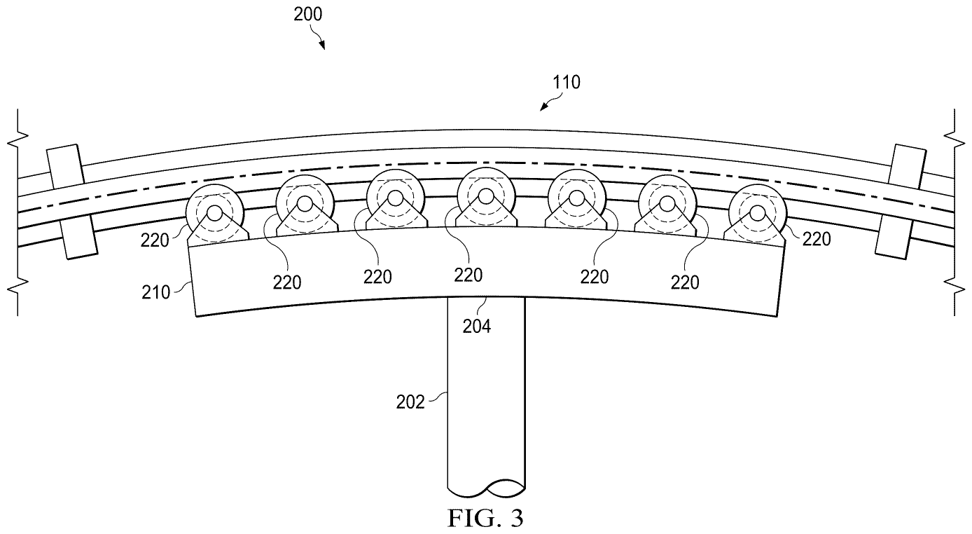

As described above, the configuration of foundations 160 may vary substantially depending on the given embodiment and particularly on the type of terrain over which conveyor system 100 extends. Referring now to FIG. 3, another embodiment of a foundation 200 is shown configured for supporting the cable assembly 110 (shown schematically in FIG. 3) of conveyor system 100 in applications in which conveyor system 100 extends over rough or uneven terrain (e.g., mountainous terrain, wetlands) where it is impractical to position the cable assembly 110 near the surface of the terrain. In this exemplary embodiment, foundations 200 are in the form of elevated support towers and thus may also be referred to herein as support towers 200.

In this exemplary embodiment, each support tower 200 comprises a vertically extending tower column 202, an idler support frame or structure 210, and a plurality of idler sheaves 220. Tower column 202 extends vertically from the surface of the terrain at a vertically lower end or base thereof (not shown in FIG. 3) to a vertically upper end 204 thereof. The length or height of tower column 202 may vary depending on the given embodiment and particularly the type of terrain over which the conveyor system 100 (comprising the support towers 200 in lieu of the foundations 160 shown in FIG. 2) extends. For example, in some embodiments, tower columns 202 may extend 20 meters (m) or greater into the air from the surface of the terrain.

The idler support frame 210 of each support tower 200 is coupled to the upper end 204 of the tower column 202 thereof and extends generally orthogonal to the tower column 202. In this exemplary embodiment, idler sheaves 220 are positioned atop the idler support frame 210 and in contact with the pair of cables 112 of cable assembly 110 whereby the weight of conveyor belt 102 and cable assembly 110 (which supports the conveyor belt 102) may be transferred to the idler support frame 210 through the idler sheaves 220. The weight of conveyor belt 102 and cable assembly 110 may in turn be transferred to the terrain from the idler support frame 210 through the tower column 202 of the support tower 200. Idler sheaves 220 may be configured similarly as the sheaves 170, 180 shown in FIG. 2, and thus will be not described in detail herein. Additionally, while idler sheaves 220 are shown positioned atop the idler support frame 210 in FIG. 3, in other embodiments, idler sheaves 220 may be located beneath and suspended from the idler support frame 210. As an example, in some embodiments, the idler sheaves 220 which support the carry side 101 of conveyor belt 102 may be positioned vertically atop the idler support frame 210 while the idler sheaves 220 which support the return side 103 of conveyor belt 102 may be positioned vertically below and suspended from the idler support frame 210.

In some embodiments, adjacent support towers 200 may be spaced at relatively large distances from each other with sections of the cable assembly 110 (located in the air many meters above the ground) spanning the gaps formed therebetween. For example, in some embodiments, adjacent support towers 200 may be spaced 100 m or more from each other, minimizing the total number of support towers 200 needed to support a conveyor system 100 of a given length. By minimizing the number of required support towers 200 the overall cost and time required for constructing a conveyor system 100 of a given length may be minimized. Additionally, the maintenance of conveyor system 100 may be simplified by localizing the maintenance of conveyor system 100 to the locations of the support towers 200 themselves given that there would typically be no need to access the portions of cable support assembly 110 spanning the gaps extending between adjacent support towers 200 given that cable support assembly 110 is, during the operation of conveyor system 100, continuously transported from one support tower 200 to another support tower 200 along the length of the conveyor system 100. Thus, if it is desired to perform maintenance to a given section of cable support assembly 110 the specific section may merely be transported to the nearest support tower 200 from which maintenance personnel of conveyor system 100 may access the section of cable assembly 110 upon which maintenance is to be performed.

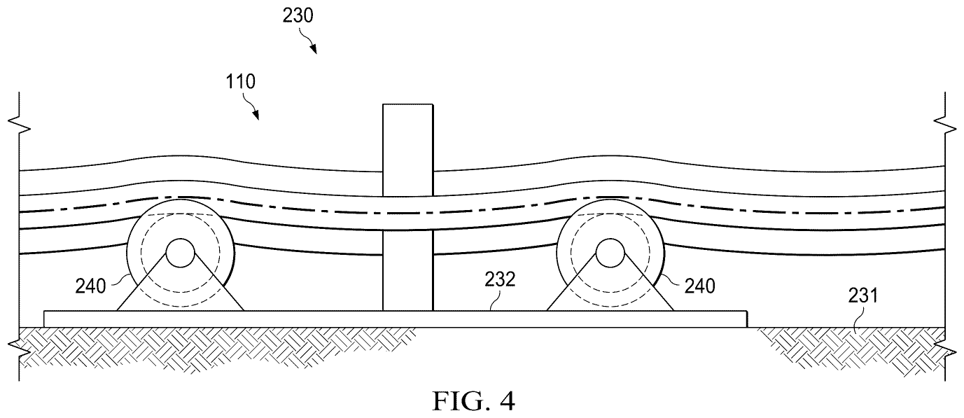

Referring to FIG. 4, another embodiment of a foundation 230 is shown for supporting cable assembly 110 of conveyor system 100 in applications in which conveyor system 100 extends across relatively flat terrain where it is unnecessary to elevate the cable assembly 110 substantially above (e.g., tends to hundreds of feet above) the surface of the terrain. Foundations 230 in this exemplary embodiment comprise stringers and thus may also be referred to herein as stringers 230.

In this exemplary embodiment, each stringer 230 comprises an idler support frame 232 located proximal the ground 231 and a plurality of idler sheaves 240 supported on the idler support frame 232 thereof. Idler sheaves 240 may be configured similarly as the sheaves 170, 180 shown in FIG. 2, and thus will be not described in detail herein. Unlike the support tower 200 shown in FIG. 3, the stringer 230 shown in FIG. 4 places both the idler support frame 232 and idler sheaves 240 in proximity to the ground 231. Additionally, while in some embodiments conveyor system 100 may comprise a plurality of separate and discrete stringers 230 (in lieu of the foundation 160 shown in FIG. 2) spaced along the length of conveyor system 100, in other embodiments conveyor system 100 may comprise a single, continuously extending stringer 230 which extends substantially or entirely between the infeed and outfeed ends of conveyor system 100. To state in other words, in some embodiments conveyor system 100 may have multiple separate foundations that are spaced apart (e.g., support towers 200) or a single, continuously extending foundation (e.g., stringer 230).

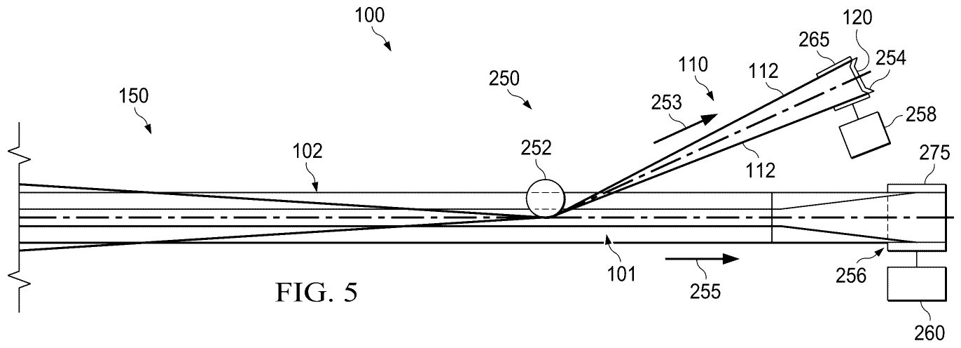

Referring now to FIGS. 5-7, an embodiment of an end section 250 of the conveyor system 100 of FIGS. 1 and 2 is shown. End section 250 may comprise an infeed end and/or an outfeed end of conveyor system 100 and may thus also be referred to herein interchangeably as end section 250, infeed end 250, and outfeed end 250. In some embodiments, a pair of end sections 250 may comprise both an infeed end 250 and an outfeed end 250 of conveyor system 100 with mid-section section 150 spanning the length of conveyor system 100 located between the infeed and outfeed ends 250. In other embodiments, end section 250 may comprise the infeed end 250 of conveyor system 100 while conveyor system 100 comprises a separate outfeed end that is configured differently than the end section 250 shown in FIGS. 5-7. Conversely, in still other embodiments, end section 250 may comprise the outfeed end 250 of conveyor system 100 while conveyor system 100 comprises a separate infeed end that is configured differently than the end section 250 shown in FIGS. 5-7.

In this exemplary embodiment, end section 250 generally includes one or more deflection sheaves 252, one or more driven or powered sheaves 265, and a driven or powered pulley 275 (sometimes also referred to as a head pulley 270). The one or more deflection sheaves 252 (referred to simply as deflection sheaves 252) of end section 250 separate the cable assembly 110 from the conveyor belt 102 whereby the carry side of cable assembly 110 is directed in a first direction 253 while the carry side 101 of conveyor belt 102 is directed in a second direction 255 disposed at a non-zero angle (e.g., an acute angle) from the first direction 253.

Cable assembly 110 is directed by deflection sheaves 252 along the first direction 253 towards a cable support transfer station 254 of the end section 250 which defines a terminal end of the longitudinal length of travel of cable assembly 110. Particularly, at cable support transfer station 254, the carry side of cable assembly 110 is looped around the one or more driven sheaves 265 (referred to simply as driven sheaves 265) positioning the looped section of cable assembly 110 on the return side thereof which travels in the opposite of first direction 253 towards the deflection sheaves 252 to be rejoined with the return side 103 of conveyor belt 102. The separation of the cable assembly 110 from conveyor belt 102 at the end section 250, among other things, permits for the carry frames 120 of support cable assembly 110 to be looped or flipped over the cable support transfer station 254 whereby the carry frames 120 may be maintained “right side up” in a preferred orientation relative to the ground. In some embodiments, support cables 112 may be pre-tensioned by end section 250 at either the infeed or outfeed end of conveyor system 100 depending on the terrain and configuration of the particular conveyor system 100. For example, the support cables 112 may be pre-tensioned via gravity, the application of hydraulic power, and/or a winch of end section 250.

The carry side 101 of the conveyor belt 102 is directed by deflection sheaves 252 along the second direction 255 towards a conveyor transfer station 256 of the end section 250 which defines a terminal end of the longitudinal length of travel of conveyor belt 102. Specifically, at conveyor transfer station 256, the carry side 101 of conveyor belt 102 is looped around the driven pulley 275 positioning the looped section of conveyor belt 102 on the return side 103 thereof which travels in the opposite of second direction 255 towards the deflection sheaves 252 to be rejoined with the return side of cable assembly 110.

In this exemplary embodiment, the deflection sheaves 252 of end section 250 are driven by a first powertrain 258 shown schematically in FIG. 5, while the driven pulley 275 is driven by a second powertrain 260 also shown schematically in FIG. 5. First powertrain 258 applies a rotational torque to the driven sheaves 265 about a rotational axis thereof which is transferred by the driven sheaves 265 to the cable assembly 110 as a tension or tensile force used to transport the cable assembly 110 across the longitudinal length of the conveyor system 100. Similarly, second powertrain 260 applies a rotational torque to the driven pulley 275 about a rotational axis thereof which is transferred by the driven pulley to the conveyor belt 102 as a tension or tensile force used to transport the conveyor belt 102 across the longitudinal length of the conveyor system 100. By separately powering the conveyor belt 102 and cable assembly 110 a greater or maximized combined tension in the cable assembly 110 and conveyor belt 102 may be achieved, where tension applied to the conveyor belt 102 and cable assembly 110 may be shared therebetween via the static friction between conveyor belt 102 and the carry frames 120 of cable assembly 110. Additionally, it may be understood that by maximizing the tension applied to conveyor belt 102 and cable assembly 110 the longitudinal length of conveyor system 100 and/or the carrying capacity and carrying speed of conveyor belt 102 may be correspondingly maximized. Further, while powertrains 258 and 260 are shown in FIG. 5 and described in this exemplary embodiment as comprising separate and distinct powertrains, in other embodiments a single, shared powertrain may apply rotational torque to both the driven sheaves 265 and the driven pulley 275.

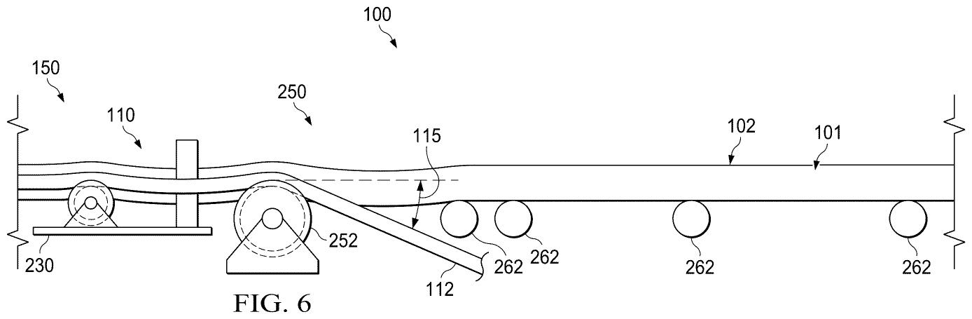

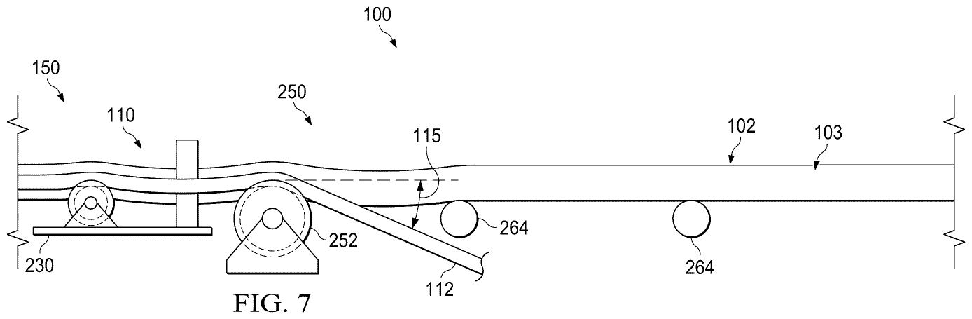

FIGS. 6 and 7 illustrate a carry side and a return side of the end section 250, respectively. Particularly, FIGS. 6 and 7 illustrate the support cables 112 extending from deflection sheaves 252 at a non-zero cable angle 115 relative to the conveyor belt 102. In some embodiments, cable angle 115 may be approximately 10 degrees or greater. In other embodiments, cable angle 114 may be approximately 15 degrees or greater. In still other embodiments, cable angle 114 may be approximately 20 degrees or greater. Additionally, as shown particularly in FIG. 6, the carry side of end section 250 of conveyor system 100 includes a plurality of carry idler rollers 262 spaced along the portion of the carry side 101 of conveyor belt 102 that is separated from the cable assembly 110. Similarly, as shown particularly in FIG. 7, the return side of end section 250 includes a plurality of return idler rollers 264 spaced along the portion of the return side 103 of conveyor belt 102 that is separated from the cable assembly 110. In this manner, carry idler rollers 262 physically support the separated portion of the carry side 101 of conveyor belt 102 while the return idler rollers 264 physically support the separated portion of the return side 103 of conveyor belt 102. Idler rollers 262 and 264 comprise hanging idler rollers in this exemplary embodiment; however, it may be understood that the configuration of idler rollers 262 and 264 may vary in other embodiments.

In the manner described, embodiments disclosed herein include conveyor systems which include a conveyor belt freely supported on a cable assembly of the conveyor system which is separate from the conveyor belt. In this manner, loads from the conveyor belt are transferred through the cable assembly to a foundation of the conveyor system. Frictional contact between the foundation and the conveyor belt/cable assembly is limited to contact between idler sheaves of the foundation and support cables of the cable assembly, minimizing frictional drag between the foundation and the conveyor belt/cable assembly transported therealong. Additionally, embodiments of conveyor systems described herein include an end section in which the conveyor belt and cable assembly of the conveyor system are separately powered and driven to maximize the combined tension in the conveyor belt and cable assembly to in-turn maximize the carrying capacity and carrying speed of the conveyor belt and/or the longitudinal length of the conveyor system. In this manner the carrying capacity and carrying speed of conveyor belt 102 and/or the longitudinal length thereof may be maximized without needing to outfit the conveyor system 100 with additional so-called booster stations used to supply additional power to the conveyor belt but which increase the overall cost and complexity of the conveyor system.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A conveyor system extending between an infeed end and an outfeed end, the conveyor system comprising:
a foundation positioned on a terrain, the foundation comprising a plurality of idler sheaves;
a cable assembly extending from the infeed end to the outfeed end and supported on the foundation, the cable assembly comprising an elongate support cable rollably supported by the plurality of idler sheaves; and
a conveyor belt extending from the infeed end to the outfeed end and freely supported on the cable assembly whereby a load path is defined that extends from the conveyor belt, through the cable assembly, and to the foundation.

2. The conveyor system of claim 1, wherein the support cable is rollably supported by the plurality of idler sheaves through metal-to-metal contact between the support cable and the plurality of idler sheaves.

3. The conveyor system of claim 1, wherein the plurality of idler sheaves each comprise a radially outer concave contact surface in contact with the support cable of the cable assembly.

4. The conveyor system of claim 1, wherein the cable assembly comprises a plurality of carry frames coupled along the support cable, and wherein the conveyor belt is held in position on the plurality of carry frames through static friction between the conveyor belt and the plurality of carry frames.

5. The conveyor system of claim 4, wherein each of the plurality of carry frames comprises a connector that couples the carry frame to the support cable.

6. The conveyor system of claim 1, wherein the foundation comprises a plurality of spaced support towers, each support tower comprising a vertically extending tower column and an idler support frame positioned atop the tower column, wherein at least one of the plurality of idler sheaves is coupled to the idler support frame.

7. The conveyor system of claim 1, wherein the foundation comprises a stringer that comprises an idler support frame positioned along the surface of the terrain and on which the plurality of idler sheaves are positioned.

8. The conveyor system of claim 1, further comprising an end section corresponding to one of the infeed end and the outfeed end of the conveyor system, wherein the end section comprises one or more driven sheaves configured to apply a tension to the cable assembly, and a driven pulley configured to separately apply a tension to the conveyor belt.

9. The conveyor system of claim 1, further comprising an end section corresponding to one of the infeed end and the outfeed end of the conveyor system, wherein the end section comprises one or more deflection sheaves configured to separate the cable assembly from the conveyor belt whereby the cable assembly is directed in a first direction while the conveyor belt is directed in a second direction disposed at a non-zero angle from the first direction.

10. A conveyor system extending between an infeed end and an outfeed end, the conveyor system comprising:
a foundation positioned on a terrain;
a cable assembly extending from the infeed end to the outfeed end and supported on the foundation;
a conveyor belt extending from the infeed end to the outfeed end and freely supported on the cable assembly whereby a load path is defined that extends from the conveyor belt, through the cable assembly, and to the foundation; and
an end section corresponding to one of the infeed end and the outfeed end of the conveyor system, wherein the end section comprises one or more driven sheaves configured to apply a tension to the cable assembly, and a driven pulley configured to separately apply a tension to the conveyor belt.

11. The conveyor system of claim 10, wherein the end section comprises a first powertrain configured to apply a rotational torque to the one or more driven sheaves, and a second powertrain configured to separately apply a rotational torque to the driven pulley.

12. The conveyor system of claim 10, wherein:
the foundation comprises a plurality of idler sheaves; and
the cable assembly comprises an elongate support cable extending from the infeed end to the outfeed end of the conveyor system and rollably supported by the plurality of idler sheaves.

13. The conveyor system of claim 10, wherein the cable assembly comprises a plurality of carry frames, and wherein the conveyor belt is held in position on the plurality of carry frames through static friction between the conveyor belt and the plurality of carry frames.

14. The conveyor system of claim 13, wherein the cable assembly comprises an elongate support cable extending from the infeed end to the outfeed end of the conveyor system, and wherein each of the plurality of carry frames comprises a connector that couples the carry frame to the support cable.

15. The conveyor system of claim 10, wherein the end section comprises one or more deflection sheaves configured to separate the cable assembly from the conveyor belt whereby the cable assembly is directed in a first direction while the conveyor belt is directed in a second direction disposed at a non-zero angle from the first direction.

16. A conveyor system extending between an infeed end and an outfeed end, the conveyor system comprising:
a foundation positioned on a terrain;
a cable assembly extending from the infeed end to the outfeed end and supported on the foundation;
a conveyor belt extending from the infeed end to the outfeed end and freely supported on the cable assembly whereby a load path is defined that extends from the conveyor belt, through the cable assembly, and to the foundation; and
an end section corresponding to one of the infeed end and the outfeed end of the conveyor system, wherein the end section comprises one or more deflection sheaves configured to separate the cable assembly from the conveyor belt whereby the cable assembly is directed in a first direction while the conveyor belt is directed in a second direction disposed at a non-zero angle from the first direction.

17. The conveyor system of claim 16, wherein:
the foundation comprises a plurality of idler sheaves; and
the cable assembly comprises an elongate support cable extending from the infeed end to the outfeed end of the conveyor system and rollably supported by the plurality of idler sheaves.

18. The conveyor system of claim 16, wherein the cable assembly comprises a plurality of carry frames, and wherein the conveyor belt is held in position on the plurality of carry frames through static friction between the conveyor belt and the plurality of carry frames.

19. The conveyor system of claim 18, wherein the cable assembly comprises an elongate support cable extending from the infeed end to the outfeed end of the conveyor system, and wherein each of the plurality of carry frames comprises a connector that couples the carry frame to the support cable.

20. The conveyor system of claim 16, wherein the foundation comprises a plurality of spaced support towers, each support tower comprising a vertically extending tower column and an idler support frame positioned atop the tower column, wherein a plurality of idler sheaves are coupled to the idler support frame and which rollably support the cable assembly.
